(19) United States
(12) Patent Application Publication
(10) Pub. No.: US 2017/0241439 A1
(43) Pub. Date: Aug. 24, 2017

(54) FOOD COOLING ASSEMBLY

(71) Applicant: Anthony Camacho, Fort Worth, TX (US)

(72) Inventor: Anthony Camacho, Fort Worth, TX (US)

(21) Appl. No.: 15/049,130

(22) Filed: Feb. 21, 2016

(51) Int. Cl. F04D 29/60; F04D 25/06; F04D 29/70; F04D 25/08

(52) U.S. Cl. CPC F04D 29/601; F04D 25/08; F04D 25/0673; F04D 25/06; F04D 29/703; F05B 2240/9151; F05B 2240/30

(57) ABSTRACT

A food cooling assembly includes a base has a top side, a bottom side and an outer perimeter edge. A mount is attached to and extends upwardly from the base. A fan is attached to the mount such that the fan is positioned over and directed downwardly toward the base. An actuator is mounted on the mount and is in electrically coupled to the fan. The actuator is actuated to an on position to turn on the fan or an off position to turn off the fan. A power supply is in electrical communication with the actuator and the fan to supply electrical power to the fan when the actuator is placed in the on position. The fan blows air downwardly on food positioned below the fan to cool the food.

### BACKGROUND OF THE DISCLOSURE

### Field of the Disclosure

The disclosure relates to food and beverage fan devices and more particularly pertains to a new food and beverage fan device for cooling a person's hot food or drink utilizing airflow.

### SUMMARY OF THE DISCLOSURE

An embodiment of the disclosure meets the needs presented above by generally comprising a base has a top side, a bottom side and an outer perimeter edge. A mount is attached to and extends upwardly from the base. A fan is attached to the mount such that the fan is positioned over and directed downwardly toward the base. An actuator is mounted on the mount and is in electrically coupled to the fan. The actuator is actuated to an on position to turn on the fan or an off position to turn off the fan. A power supply is in electrical communication with the actuator and the fan to supply electrical power to the fan when the actuator is placed in the on position. The fan blows air downwardly on food positioned below the fan to cool the food.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a food cooling assembly according to an embodiment of the disclosure.

FIG. 2 is a top view of an embodiment of the disclosure.

FIG. 3 is a broken cross-sectional view of an embodiment of the disclosure taken along line 3-3 of FIG. 2.

FIG. 4 is a front view of an embodiment of the disclosure.

FIG. 5 is a side in-use view of an embodiment of the disclosure.

FIG. 6 is a schematic box diagram view of an embodiment of the disclosure.

### DESCRIPTION OF THE PREFERRED EMBODIMENT

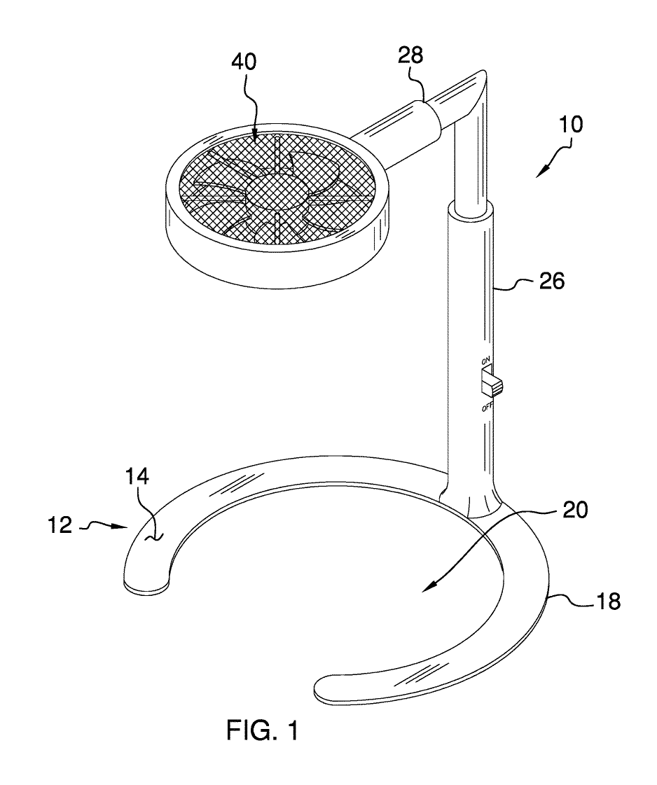

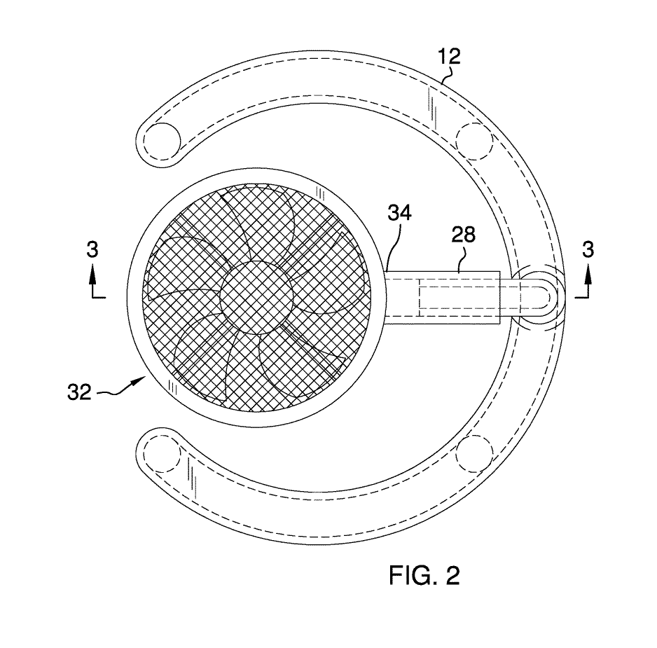

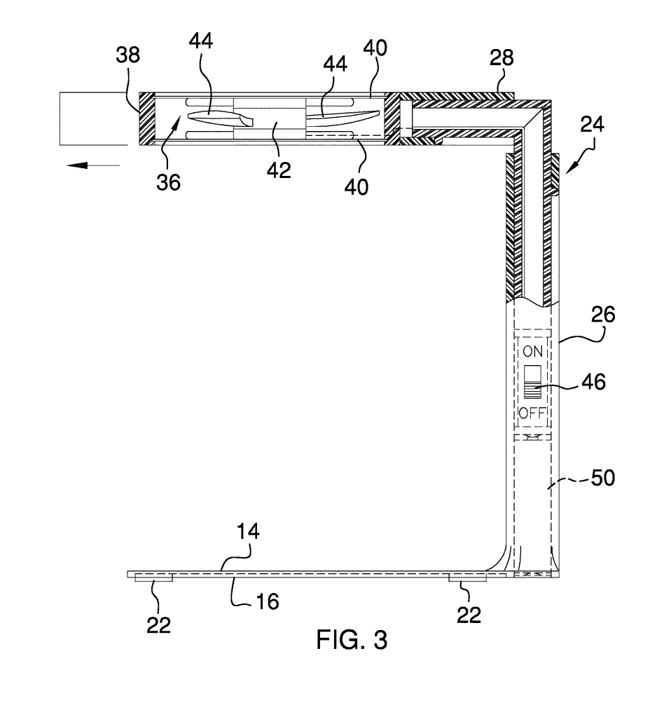

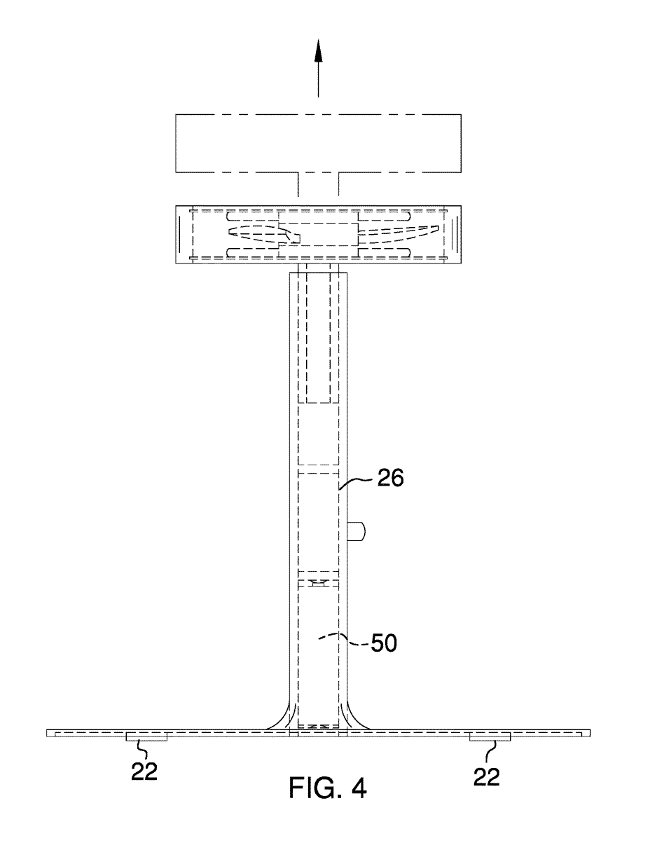

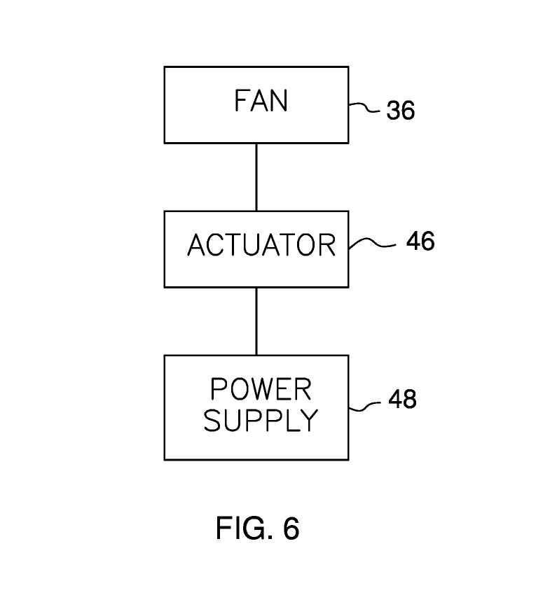

With reference now to the drawings, and in particular to FIGS. 1 through 6 thereof, a new food and beverage fan device embodying the principles and concepts of an embodiment of the disclosure and generally designated by the reference numeral 10 will be described.

As best illustrated in FIGS. 1 through 6, the food cooling assembly 10 generally comprises a base 12 that has a top side 14, a bottom side 16 and an outer perimeter edge 18. The base 12 has a central area 20 that may be open and the outer perimeter edge 18 may be arcuate such that a semi-circular configuration is provided. A plurality of non-skid feet 22 may be attached to the bottom side of the base.

A mount 24 is attached to and extends upwardly from the base 12. The mount 24 includes a vertical support 26 that is attached to and extends upwardly from the top side 14. The vertical support 26 is positioned adjacent to the outer perimeter edge 18. The vertical support 26 has a vertically oriented longitudinal axis that is perpendicular to a plane of the top side 14 of the base 12. The vertical support 26 may be telescopic and has an adjustable height. Generally, the vertical support 26 has a maximum height that is less than 12.0 inches and may be about approximately 8.0 inches. A horizontal support 28 is attached to the vertical support 26 adjacent to an upper end 30 of the vertical support 26. The horizontal support 28 extends laterally away from the vertical support 26 and extends over the base 12 as can be seen in FIG. 1. The horizontal support 28 may also be telescopic and thereby have an adjustable length which would typically be between 3.0 inches and 9.0 inches. A frame 32 is attached to a distal end 34 of the horizontal support 28 with respect to the vertical support 26.

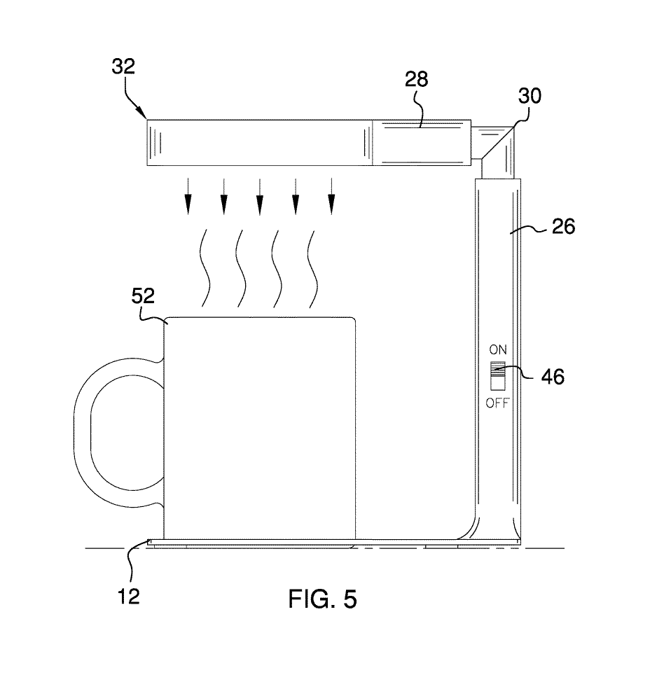

A fan 36 is attached to the mount 24 such that the fan 36 is positioned over and directed downwardly toward the base 12. The fan 36 is mounted in the frame 32 wherein the frame 32 includes a perimeter wall 38 and screens 40 positioned above and below the fan 36. The frame 32 would typically be static to retain the fan 36 in a downwardly facing orientation; however the frame 32 may be rotatable with respect to the horizontal support 28. The fan 36 is conventional and includes an electric motor 42 and a plurality of blades 44 mechanically coupled to the motor 42. An actuator 46 is mounted on the mount 24 and is in electrically coupled to the fan 36. The actuator 46 is actuated to an on position to turn on the fan 36 or an off position to turn off the fan 36. The actuator 46 may be positioned on the vertical support 26 as shown in FIG. 5. A power supply 48 is in electrical communication with the actuator 46 and the fan 36 to supply electrical power to the fan 36 when the actuator 46 is placed in the on position. The power supply 48 may comprise a battery 50 or a plug couplable to an electric outlet. Should a battery 50 be used, the battery may be a rechargeable battery electrically couplable to an outlet for recharging purposes or electrically connected to photovoltaic cells positioned on the mount 24.

In use, a person may place a hot beverage 52, such as coffee, or food, such as soup, so that the fan 36 directs air downwardly onto the beverage 52 or food to quickly cool such without need of the person to blow on the beverage 52 or food. The base 12 and vertical support 26 are positioned relatively to each other to place the fan 36 above the beverage 52 or food in a stable configuration to prevent the falling over of the fan 36 into the food being cooled.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food cooling system comprising:
a base having a top side, a bottom side and an outer perimeter edge;
a mount being attached to and extending upwardly from said base;
a fan being attached to said mount such that said fan is positioned over and directed downwardly toward said base;
an actuator being mounted on said mount and being in electrically coupled to said fan, said actuator being actuated to an on position to turn on said fan or an off position to turn off said fan;
a power supply being in electrical communication with said actuator and said fan to supply electrical power to said fan when said actuator is placed in said on position; and
wherein said fan is configured to blow air downwardly on food positioned below said fan to cool the food.

2. The food cooling system according to claim 1, wherein said base has a central area being open.

3. The food cooling system according to claim 2, wherein said base has said outer perimeter edge being arcuate.

4. The food cooling system according to claim 1, further including a plurality of non-skid feet being attached to said bottom side of said base.

5. The food cooling system according to claim 1, wherein said mount includes:
a vertical support being attached to and extending upwardly from said top side;
a horizontal support being attached to said vertical support adjacent to an upper end of said vertical support, said horizontal support extending laterally away from said vertical support and extending over said base;
a frame being attached to a distal end of said horizontal support with respect to said vertical support, said fan being mounted in said frame.

6. The food cooling system according to claim 5, wherein said vertical support is positioned adjacent to said outer perimeter edge.

7. The food cooling system according to claim 6, wherein said vertical support having a vertically oriented longitudinal axis being perpendicular to a plane of said top side of said base.

8. The food cooling system according to claim 5, wherein said vertical support is telescopic and has an adjustable height.

9. The food cooling system according to claim 8, wherein said vertical support has a maximum height being less than 12.0 inches.

10. The food cooling system according to claim 5, wherein said vertical support has a height being less than 12.0 inches.

11. The food cooling system according to claim 8, wherein said horizontal support is telescopic and having an adjustable length.

12. The food cooling system according to claim 5, wherein said horizontal support is telescopic and having an adjustable length.

13. The food cooling system according to claim 9, wherein said horizontal support is telescopic and having an adjustable length.

14. A food cooling system comprising:
a base having a top side, a bottom side and an outer perimeter edge, said base having a central area being open, said base having said outer perimeter edge being arcuate, a plurality of non-skid feet being attached to said bottom side of said base;
a mount being attached to and extending upwardly from said base, said mount including:
a vertical support being attached to and extending upwardly from said top side, said vertical support being positioned adjacent to said outer perimeter edge, said vertical support having a vertically oriented longitudinal axis being perpendicular to a plane of said top side of said base, said vertical support being telescopic and having an adjustable height, said vertical support having a maximum height being less than 12.0 inches;
a horizontal support being attached to said vertical support adjacent to an upper end of said vertical support, said horizontal support extending laterally away from said vertical support and extending over said base, said horizontal support being telescopic and having an adjustable length;
a frame being attached to a distal end of said horizontal support with respect to said vertical support;
a fan being attached to said mount such that said fan is positioned over and directed downwardly toward said base, said fan being mounted in said frame;
an actuator being mounted on said mount and being in electrically coupled to said fan, said actuator being actuated to an on position to turn on said fan or an off position to turn off said fan;
a power supply being in electrical communication with said actuator and said fan to supply electrical power to said fan when said actuator is placed in said on position.
